(19) United States
(12) Patent Application Publication
(10) Pub. No.: US 2015/0311740 A1
(43) Pub. Date: Oct. 29, 2015

(54) ENCAPSULATED INDUCTIVE CHARGING COIL

(71) Applicant: Apple Inc., Cupertino, CA (US)

(72) Inventors: Alvin J. Hilario, Cupertino, CA (US); Darshan R. Kasar, Cupertino, CA (US); Jason J. Huey, Cupertino, CA (US); Kevin M. Keeler, Cupertino, CA (US)

(73) Assignee: Apple Inc., Cupertino, CA (US)

(21) Appl. No.: 14/263,792

(22) Filed: Apr. 28, 2014

(51) Int. Cl. H02J 7/02; H01F 41/00; H01F 27/32; H02J 7/00; H01F 27/28

(52) U.S. Cl. CPC H02J 7/025; H02J 7/0042; H01F 27/28; H01F 27/327; H01F 41/005

(57) ABSTRACT

At least one inductive charging coil is encapsulated within one or more walls of the enclosure of an electronic device. The inductive charging coil or coils may be insert molded into the enclosure of the electronic device. The electronic device can be a transmitter device or a receiver device in an inductive charging system.

### TECHNICAL FIELD

The invention relates generally to inductive charging and/or communication, and more particularly to encapsulating or embedding one or more inductive charging coils in the enclosure of an electronic device.

### BACKGROUND

An inductive charging system transfers energy from a transmitter coil in one device to a receiver coil in another device. Essentially, a current in the transmitter coil produces a magnetic field that induces a current in the receiver coil. The current induced in the receiver coil can be used to charge a battery in the receiver device, to operate the receiver device, and/or to transfer communication or control signals to the receiver device. FIG. 1 is a cross-sectional view of a prior art inductive charging system. The inductive charging system 100 includes a charging device 102 that transmits power and/or signals to an electronic device 104 through inductive coupling between the transmitter coil 106 in the charging device and the receiver coil 108 in the electronic device. The transmitter coil 106 is positioned inside the charging device 102 in an interior area 110 that is defined by the enclosure 112 of the charging device. In particular, the transmitter coil 106 is affixed to an interior wall of the enclosure 112 that is adjacent to the charging surface 114. Similarly, the receiver coil 108 is positioned inside the electronic device 104 in an interior area 116 that is defined by the enclosure 118 of the electronic device. The receiver coil 106 is also affixed to the interior wall of the enclosure 118 that is adjacent to the charging surface 114.

Peak efficiency for the transfer of power or signals typically occurs when the transmitter and receiver coils are properly aligned and the magnetic field produced by the transmitter coil 106 surrounds the receiver coil 108 so that the energy passing through the receiver coil substantially equals the energy in the transmitter coil. However, this restricts or limits the distance that can exist between the transmitter and receiver coils. As the distance D increases, losses in the transmitter coil reduces the efficiency of the power transfer. In some situations, the power transfer efficiency can decrease exponentially as the distance between the transmitter and receiver coils increases.

### SUMMARY

In one aspect, at least one inductive charging coil is encapsulated within one or more walls of the enclosure of the electronic device. The electronic device can be any suitable type of electronic device, including, but not limited to, a digital media player, a smart telephone, a wearable electronic or communication device, a health monitoring device, a tablet computing device, and an inductive charging device. The charging device can be a charging dock that receives an electronic device on a charging surface, or the charging device can be adapted to be inserted into a charging port in an electronic device. The inductive charging coil or coils can have any given shape or design, such as a spiral design, a conical design, a planar design, a toroidal design, and a helical design. In one embodiment, the inductive charging coil or coils are encapsulated within the enclosure by insert molding each coil into the one or more walls of the enclosure. In another embodiment, the inductive charging coil(s) are encapsulated within an opening that is formed in the enclosure and secured mechanically in the opening.

In another aspect, an inductive charging system includes a transmitter device that includes a transmitter coil, and a receiver device that includes a receiver coil. At least one of the transmitter coil and the receiver coil is encapsulated in an enclosure of a respective device. For example, the transmitter coil can be insert molded into the enclosure of the transmitter device, the receiver coil can be insert molded into the enclosure of the receiver device, or both the transmitter coil and the receiver coil can be insert molded into their respective enclosures.

In yet another aspect, a method for positioning one or more inductive charging coils in an enclosure of an electronic device can include positioning the inductive charging coil in a mold that defines a shape of at least a portion of the enclosure, and encapsulating each inductive charging coil in a material that forms at least one wall of the enclosure. The one or more inductive charging coils can be encapsulated in the enclosure by injecting a material into the mold to form at least the portion of the enclosure.

### BRIEF DESCRIPTION OF THE DRAWINGS

Embodiments of the invention are better understood with reference to the following drawings. The elements of the drawings are not necessarily to scale relative to each other. Identical reference numerals have been used, where possible, to designate identical features that are common to the figures.

FIG. 1 is a cross-sectional view of a prior art inductive charging system;

FIG. 2 depicts a top view of one example of an inductive charging system;

FIGS. 3-5 are simplified cross-sectional views of the inductive charging dock 202 and the electronic device 204 taken along line A-A in FIG. 2;

FIGS. 6-7 illustrate perspective views of another example of an inductive charging system;

FIG. 8 is a simplified cross-sectional view of the charging device 602 and the charging port 606 taken along line B-B in FIG. 7;

FIGS. 9-11 depict example shapes that are suitable for an inductive charging coil;

FIGS. 12-13 are cross-sectional views of an enclosure of an electronic device;

FIG. 14 is a flowchart of a first method for positioning one or more inductive charging coils in an enclosure; and

FIG. 15 is a flowchart of a second method for positioning one or more inductive charging coils in an enclosure.

### DETAILED DESCRIPTION

Embodiments described herein encapsulate at least one inductive charging coil within one or more walls of the enclosure of an electronic device. In one embodiment, the inductive charging coil or coils is insert molded into the enclosure of the electronic device. The electronic device can be a charging device, an electronic device that is receiving power from a charging device, or both the charging device and the electronic device that is receiving power from the charging device. Encapsulating the inductive charging coil or coils in the enclosure can reduce the distance between the transmitter coil and the receiver coil, which can result in increased power or signal transfer efficiency. The encapsulated inductive charging coil(s) may strengthen the wall or enclosure and may reduce the thermal, mechanical, and/or chemical stress experienced by the enclosure. Additionally, the encapsulated inductive charging coil(s) are better shielded from corrosion, contaminants, and damage. This may also allow the interior area of the electronic device (the area defined by and within the enclosure) to be optimized based on design requirements of the electronic device.

Embodiments described herein can transfer energy from a transmitter device to a receiver device to charge a battery or to operate the receiver device. Additionally or alternatively, communication or control signals can be transmitted to the receiver device through the inductive coupling between the transmitter and receiver coils. For example, while charging, high frequency pulses can be added on top of the inductive charging frequency to enable both charging and communication. Alternatively, the transferred energy can be used solely for communication. Thus, the terms “energy”, “signal”, or “signals” are meant to encompass transferring energy for wireless charging, transferring energy as communication and/or control signals, or both wireless charging and the transmission of communication and/or control signals.

Referring now to FIG. 2, there is shown a top view of one example of an inductive charging system. The inductive charging system 200 includes two electronic devices, a charging device 202 (e.g., charging dock) and a portable electronic device 204. In the illustrated embodiment, the portable electronic device is a smart telephone. In other embodiments, the portable electronic device can be other types of electronic devices, including, but not limited to, a digital media player, a wearable electronic or communication device, a health monitoring device, a tablet computing device, and any other type of electronic device that includes one or more inductive charging coils.

To transfer one or more signals to the electronic device 204, the electronic device 204 is placed on a charging surface 206 of the charging dock 202. The charging dock 202 may be connected to a power source (e.g., a wall outlet) through a power cord or connector (not shown). The charging dock 202 includes one or more inductive charging coils that transfer energy to one or more inductive charging coils in the portable electronic device 204. Thus, the charging dock 202 is a transmitter device with a transmitter coil or coils and the portable electronic device 204 is a receiver device with one or more receiver coils. As described earlier, the transferred energy can be used to charge a battery in the electronic device 204, to operate the electronic device, to transfer communication signals, and/or to transfer control signals.

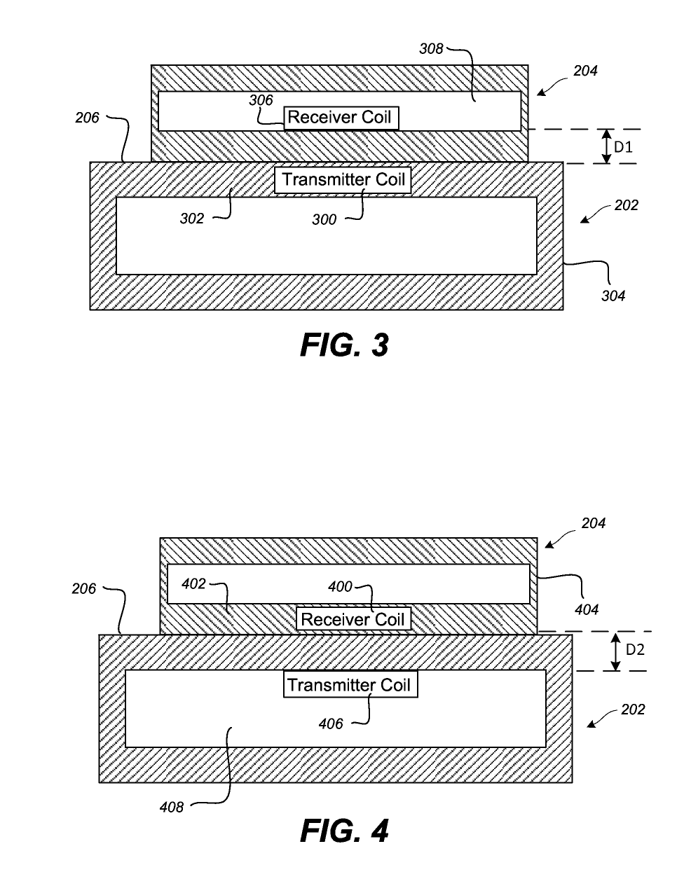

FIGS. 3-5 are simplified cross-sectional views of the inductive charging dock 202 and the electronic device 204 taken along line A-A in FIG. 2. Those skilled in the art will recognize that the charging dock 202 and the electronic device 204 can each include other mechanical, structural, and electrical components such as circuit boards, a processing device, a power source or battery, a display, input and output devices such as buttons, microphones, speakers, and keyboards, and memory that may be present in a cross-sectional or perspective view. However, these other components are omitted in FIGS. 3-13 for clarity and simplicity.

In the FIG. 3 embodiment, the transmitter coil 300 is encapsulated within the wall 302 of the enclosure 304 of the charging dock 202. In particular, the outer surface of the wall 302 forms, or is at least a part of, the charging surface 206 of the charging dock 202. The receiver coil 306 can be located within the interior area 308 of the electronic device 204 and affixed to the interior wall that is adjacent to the charging surface 206. Although only one transmitter coil and one receiver coil are shown in FIGS. 3-5, other embodiments can use multiple transmitter coils and/or receiver coils and may position the coils at different locations in the device(s).

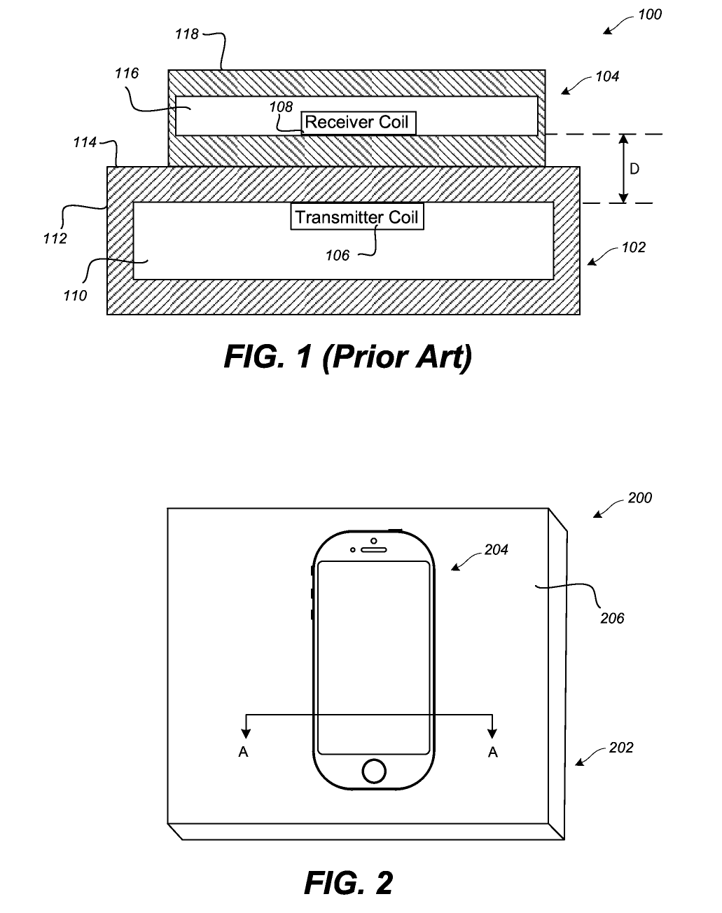

The receiver coil 306 is aligned with the transmitter coil 300 by positioning the receiver coil 306 substantially above or adjacent to the transmitter coil 300 when one or more signals are to be transferred from the charging dock 202 to the electronic device 204. Embedding the transmitter coil 300 in the wall 302 of the enclosure 304 positions the transmitter coil closer to the charging surface 206, which in turn places the transmitter coil closer to the receiver coil. The distance D1 between the transmitter and receiver coils can be less than the distance D in FIG. 1 when the transmitter coil 300 is encapsulated in the wall 302.

In another embodiment, the receiver coil 400 is embedded in the wall 402 of the enclosure 404 of the electronic device 204 (see FIG. 4). In particular, the wall 302 can be adjacent to the charging surface 206 of the charging dock 202. The transmitter coil 406 can be located within the interior area 408 of the charging dock 204 and affixed to the interior wall that has an outer surface that forms, or is included in the charging surface 206. The receiver coil 400 is positioned closer to the charging surface 206 when the receiver coil is encapsulated in the wall 402. The distance D2 between the transmitter and receiver coils can be less than the distance D in FIG. 1 when the receiver coil 400 is embedded in the wall 402.

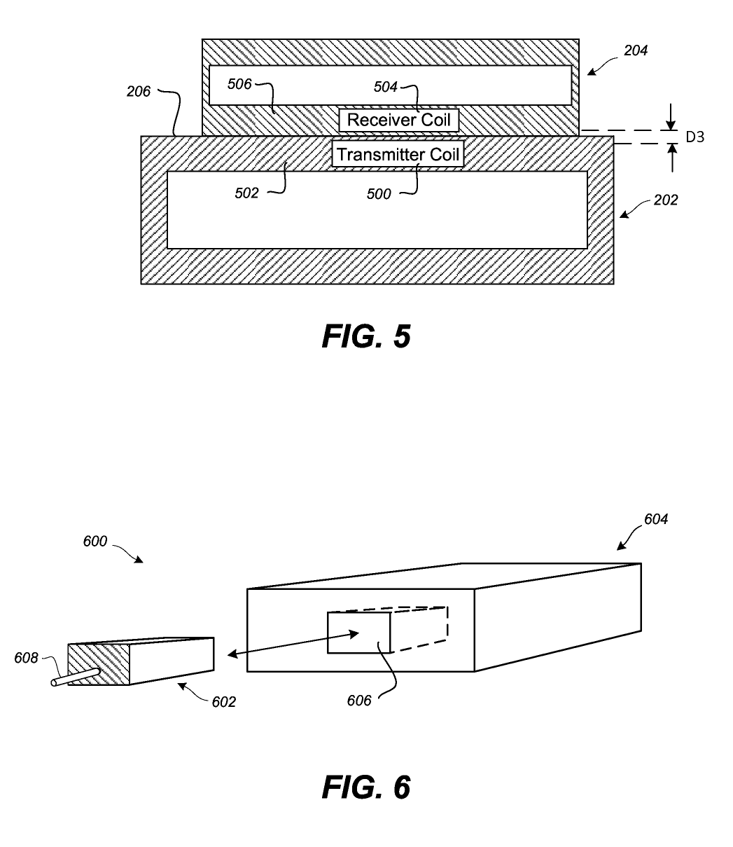

And in the embodiment shown in FIG. 5, both coils are encapsulated in the walls of their respective enclosures that are closest to the charging surface 206. The transmitter coil 500 is embedded in the wall 502 of the charging device 202 and the receiver coil 504 is encapsulated in the wall 506 of the electronic device 204. The distance D3 between the transmitter and receiver coils 500, 502 can be less than the distance D in FIG. 1, and less than the distances D1 and D2 in FIGS. 3 and 4, respectively, when the transmitter and receiver coils are embedded in the enclosures of the charging dock and the electronic device.

Encapsulating the transmitter coil(s) and/or the receiver coil(s) in their respective enclosures can increase the efficiency of the energy transfer because the coils are closer together. Losses in the transmitter coil can be reduced when the distance between the transmitter and receiver coils is decreased. Additionally, the embedded inductive charging coil(s) may strengthen the wall or the enclosure and may reduce the thermal, mechanical, and/or chemical stress experienced by the enclosure. Additionally, the encapsulated inductive charging coil(s) are better shielded from corrosion, contaminants, and damage. And in some embodiments, the encapsulated coil or coils may allow the interior area of the electronic device (the area defined by and within the enclosure) to be optimized based on design requirements of the electronic device. For example, the thickness of the wall encapsulating the coil can be reduced, and based on this reduced thickness, the interior area of the electronic device can be increased for more component placement area. Alternatively, based on the reduced wall thickness, the interior area of the electronic device can be decreased to produce a smaller profile for the electronic device.

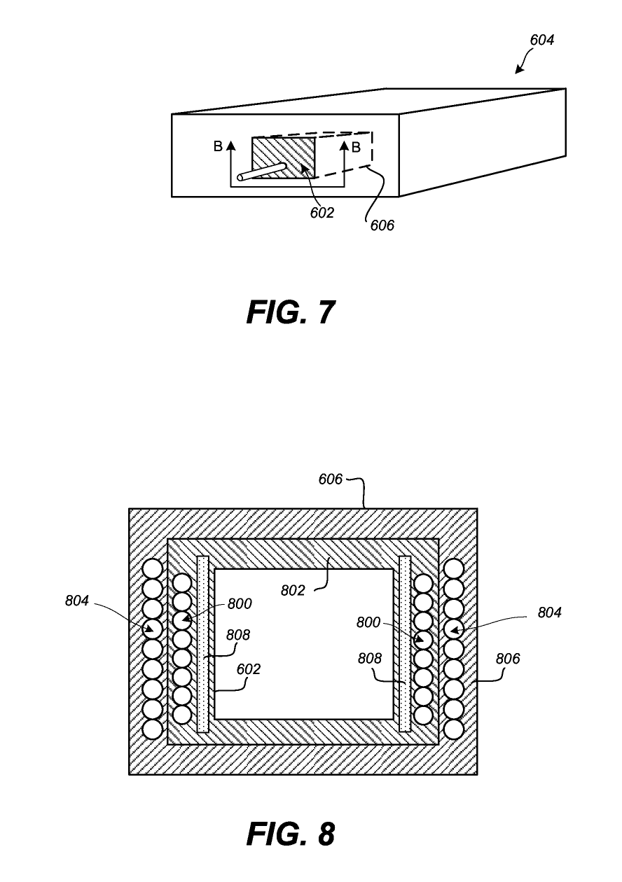

Referring now to FIGS. 6-7, there are shown perspective views of another example of an inductive charging system. The charging system 600 includes a charging device 602 and an electronic device 604. The charging device 602 is adapted to be inserted into and removed from a charging port 606 in the electronic device, and the charging port 606 is adapted to receive the charging device 602. FIG. 6 illustrates the charging device 602 removed from the charging port 606, and FIG. 7 depicts the charging device 602 inserted into the charging port 604. The charging device 602 can be connected to a power source (e.g., a wall outlet) using the power cord or connector 608. The charging device and charging port can be shaped differently in other embodiments.

FIG. 8 is a simplified cross-sectional view of the charging device 602 and the charging port 606 taken along line B-B in FIG. 7. One or more transmitter coils 800 is embedded in the enclosure 802 of the charging device 602. One or more receiver coils 804 is encapsulated in the enclosure or walls 806 that form the charging port 606. Like the embodiments in FIGS. 3-5, the energy transfer between the transmitter coil(s) 800 and the receiver coil(s) 804 can be more efficient when the transmitter and receiver coils are closer together.

In some embodiments, a shield 808 can be included in one or more walls of the enclosure 802 of the charging device 602 to direct the magnetic flux of the transmitter coil(s) 800 toward the receiver coil(s) 804. The shield or shields 808 can be made of any suitable material and each shield can be arranged in any given design or shape. Additionally or alternatively, a shield can be included in one or more walls of the enclosure 806 of the charging port 606. As one example, a shield in the wall(s) of the enclosure 806 can be positioned between a receiver coil 804 and the exterior surface of the enclosure 806.

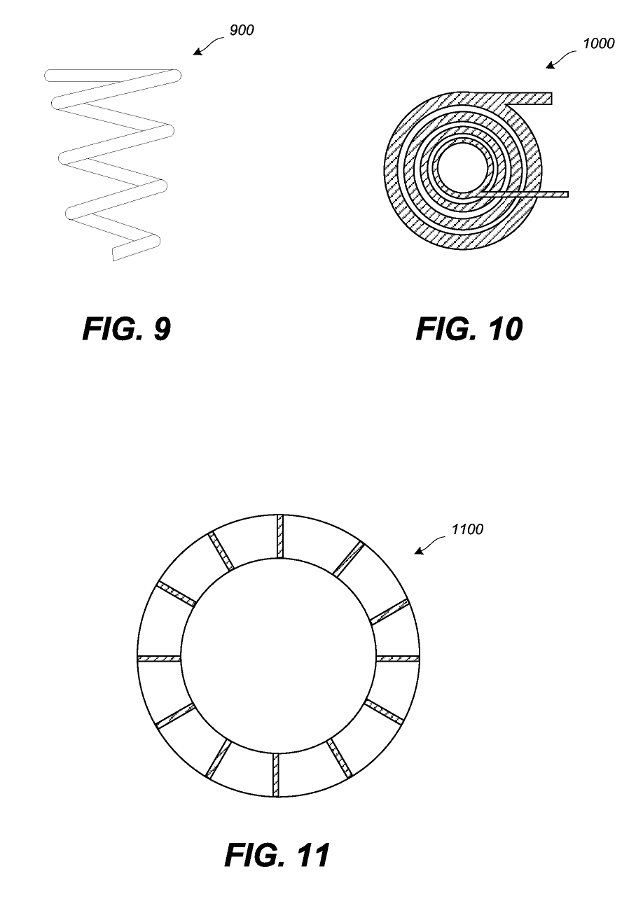

Referring now to FIGS. 9-11, there are shown example shapes that are suitable for an inductive charging coil. Example configurations for an inductive charging coil include, but are not limited to, a conical design, a planar design, a toroidal design, a helical design, a circular design, a spiral design, a basket weave design, or a spider web design. Inductive charging coils in these and other designs can include one or more conductors or wires. FIG. 9 depicts a conical-shaped inductive charging coil 900. FIG. 10 illustrates a planar-shaped inductive charging coil 1000. And FIG. 11 shows a toroidal-shaped inductive charging coil 1100.

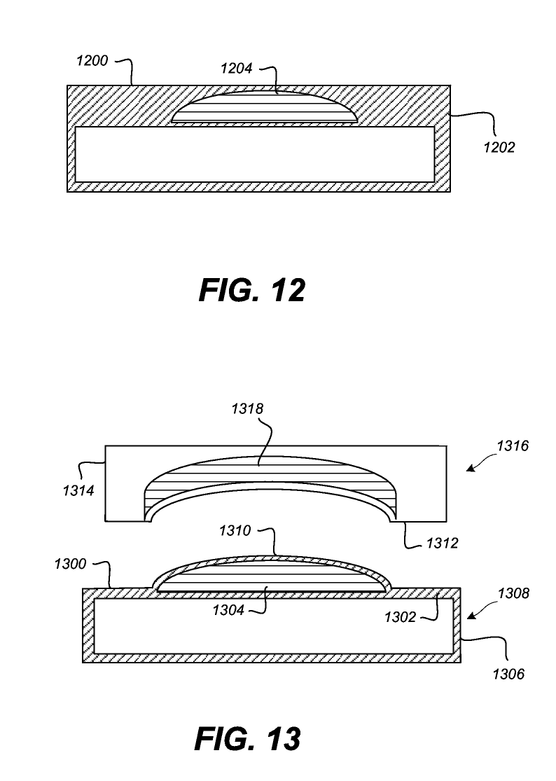

FIGS. 12-13 are cross-sectional views of an enclosure of an electronic device. In FIG. 12, an inductive charging coil 1200 is embedded in the wall 1202 of an enclosure 1204. The outer surface 1206 of the wall 1202 is substantially planar. The inductive charging coil 1200 can have any given shape. Thus, the outer surface 1206 may not conform or correspond to the shape of the inductive charging coil 1200 in some embodiments.

In other embodiments, at least a portion of the outer surface 1300 of a wall 1302 that encapsulates an inductive charging coil 1304 can correspond to the shape of the inductive charging coil 1304, as shown in FIG. 13. For example, the enclosure 1306 of a transmitter device 1308 can include a raised region 1310 that corresponds to the shape of the transmitter coil 1304. Additionally, in some embodiments, the shape of an outer surface 1312 of the enclosure 1314 for a receiver device 1316 can correspond to the shape of the outer surface 1300 of the enclosure 1306 of the transmitter device 1308. These corresponding shapes may make aligning the transmitter and receiver coils 1304, 1318 easier.

Alternatively, in some embodiments, at least a portion of the outer surface of a wall that encapsulates a receiver coil in the receiver device can correspond to the shape of the receiver coil. The shape of an outer surface of the enclosure for the transmitter device may correspond to the shape of the outer surface of the enclosure for the receiver device.

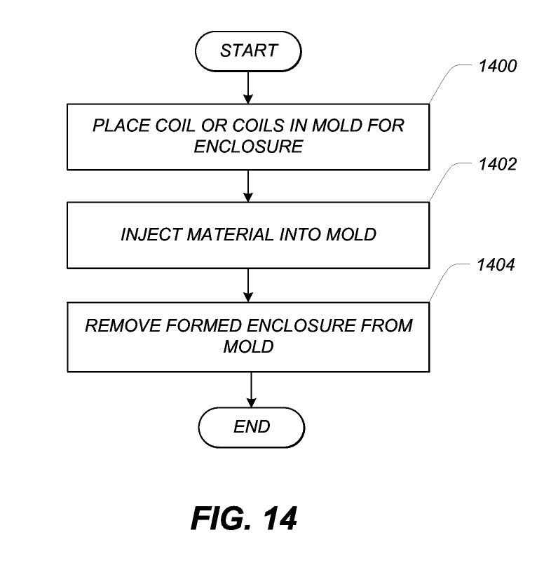

Referring now to FIG. 14, there is shown a flowchart of a first method for positioning one or more inductive charging coils in an enclosure. Initially, as shown in block 1400, one or more coils are placed in a mold that defines or forms at least a portion of the enclosure of an electronic device. As described earlier, the electronic device may be for a transmitter device or for a receiver device. Any suitable type of inductive charging coil may be used. For example, an inductive charging coil can be formed with a conductor wrapped around a core material. The conductor can be a metal conductor, such as a copper wire, and the core material can be a ferrous material.

Material to form the enclosure is then injected into the mold at block 1402. The material can be made of any suitable material. An example material includes a synthetic resin, such as a polycarbonate material. Next, as shown in block 1404, the formed enclosure or portion of the enclosure is then removed from the mold. The one or more inductive charging coils are encapsulated in the formed enclosure or portion of the enclosure.

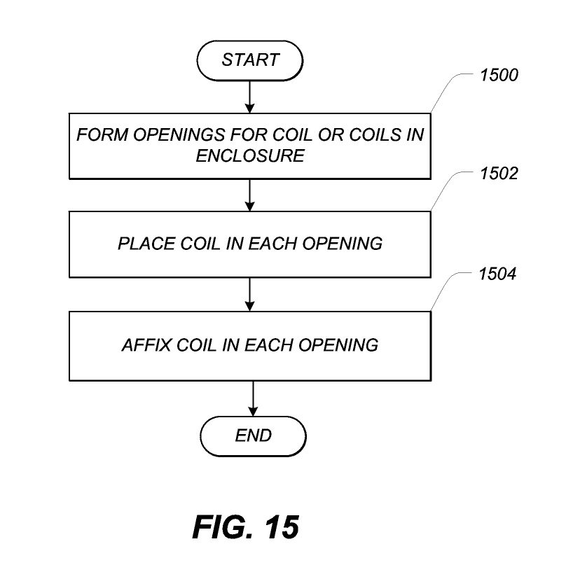

FIG. 15 is a flowchart of a second method for positioning one or more inductive charging coils in an enclosure. Initially, an opening for an inductive charging coil can be formed in one or more walls of an enclosure, as shown in block 1500. Any suitable method can be used to form an opening in the wall of the enclosure. As one example, an opening can be etched or drilled into a wall of the enclosure.

Next, as shown in block 1502, the inductive charging coil can be placed in each opening. The inductive charging coil can then be affixed or secured in the opening. For example, the inductive charging coil can be secured mechanically in the opening. As one example, the inductive charging coil may be soldered or affixed with a fastener. Alternatively, the inductive charging coil can be secured with an adhesive.

In some embodiments, the inductive charging coil or coils can be coated with a material that may protect the coil(s) from damage, material ingress, and/or other possible environmental failures. Any suitable material or combination of materials can be used as a coating. For example, a UV-cure epoxy may cover or coat the one or more inductive charging coils.

Various embodiments have been described in detail with particular reference to certain features thereof, but it will be understood that variations and modifications can be effected within the spirit and scope of the disclosure. And even though specific embodiments have been described herein, it should be noted that the application is not limited to these embodiments. In particular, any features described with respect to one embodiment may also be used in other embodiments, where compatible. Likewise, the features of the different embodiments may be exchanged, where compatible.

We claim:

1. An electronic device comprising one or more inductive charging coils encapsulated within one or more walls of an enclosure of the electronic device.

2. The electronic device as in claim 1, wherein the one or more inductive charging coils are insert molded into the one or more walls of an enclosure of the electronic device.

3. The electronic device as in claim 1, wherein the electronic device comprises a charging device.

4. The electronic device as in claim 3, wherein the charging device comprises a charging device adapted to be inserted into a charging port in an electronic device.

5. The electronic device as in claim 3, wherein the charging device comprises a charging dock.

6. The electronic device as in claim 1, wherein the electronic device comprises one of a wearable electronic device and a portable electronic device.

7. The electronic device as in claim 1, wherein at least one inductive charging coil comprises a planar inductive charging coil.

8. The electronic device as in claim 1, wherein at least one inductive charging coil comprises a toroidal-shaped inductive charging coil.

9. The electronic device as in claim 1, wherein at least one inductive charging coil comprises a conical-shaped inductive charging coil.

10. The electronic device as in claim 1, wherein a shape of an outer surface of at least one wall corresponds to a shape of at least one inductive charging coil.

11. An inductive charging system, comprising:
a transmitter device comprising a transmitter coil; and
a receiver device comprising a receiver coil, wherein at least one of the transmitter coil and the receiver coil is encapsulated in an enclosure of a respective device.

12. The inductive charging system as in claim 11, wherein the transmitter coil is insert molded into the enclosure of the transmitter device.

13. The inductive charging system as in claim 11, wherein the receiver coil is insert molded into the enclosure of the receiver device.

14. The inductive charging system as in claim 11, wherein the transmitter device comprises a charging device.

15. The inductive charging system as in claim 14, wherein the charging device comprises a charging device adapted to be inserted into a charging port in an electronic device.

16. The inductive charging system as in claim 11, wherein the receiver device comprises one of a wearable electronic device and a portable electronic device.

17. A method for positioning an inductive charging coil in an enclosure of an electronic device, the method comprising:
positioning the inductive charging coil in a mold that defines a shape of at least a portion of the enclosure; and
injecting a material into the mold to form at least the portion of the enclosure, wherein the material encapsulates the inductive charging coil into the enclosure.

18. The method as in claim 17, wherein the electronic device comprises a charging device.

19. The method as in claim 17, wherein the electronic device comprises one of a wearable electronic device and a portable electronic device.

20. The method as in claim 17, wherein the inductive charging coil comprises one of a flat inductive charging coil, a toroidal-shaped inductive charging coil, and a conical-shaped inductive charging coil.
